(19) United States
(12) Patent Application Publication
(10) Pub. No.: US 2005/0258568 A1
(43) Pub. Date: Nov. 24, 2005

(54) Method for manufacturing wax pattern of golf club head

(76) Inventor: Wen-Ching Hou, Kaohsiung (TW)

Correspondence Address: BIRCH STEWART KOLASCH & BIRCH, PO BOX 747, FALLS CHURCH, VA, 22040-0747, US

(21) Appl. No.: 10/847,375

(22) Filed: May 18, 2004

(51) Int. Cl. B29C 33/40

(52) U.S. Cl. 264/225

(57) ABSTRACT

A method for manufacturing a wax pattern of a golf club head includes preparing an inner mold. At least a portion of the inner mold is made of a liquid-soluble material. The liquid-soluble portion includes an outer periphery complementary to at least a portion of an inner perimeter of a golf club head. The inner mold is then placed in a cavity of an outer mold. A periphery delimiting the cavity is complementary to an outer perimeter of the golf club head. Molten wax is filled into a space between the outer mold and the inner mold to form a heat-melting wax pattern. The liquid-soluble portion of the inner mold is dissolved with a liquid to allow removal of the heat-melting wax pattern.

### BACKGROUND OF THE INVENTION

1. Field of the Invention

The present invention relates to a method for manufacturing a wax pattern of a golf club head. In particular, the present invention relates to a method that uses a liquid-soluble core to produce a heat-melting wax pattern, thereby simplifying the process for manufacturing a golf club head.

2. Description of Related Art

Taiwan Utility Model Publication No. 563599 entitled “WAX PATTERN STRUCTURE FOR GOLF CLUB HEAD” discloses a wax pattern that is formed by injection molding through the use of a plurality of outer molds, a plurality cores (or inner molds), and a supporting member. The outer molds are assembled to form a cavity having a shape corresponding to that of a golf club head. The cores are assembled together and engaged with the supporting member. The supporting member supports the cores in the cavity through a sprue of the cavity. A wax-receiving space is delimited between an inner periphery delimiting the cavity of the outer molds and an outer periphery of the cores. Molten wax is poured into the wax-receiving space and then hardened to form a wax pattern of a golf club head with the desired shape. The outer molds, the supporting member, and the cores are removed in sequence to obtain the hollow wax pattern, which can be used to produce a golf club head casting by investment casting.

Although the above-mentioned method is suitable for mass production of integrally formed golf club heads, it cannot be applied to golf club heads with a complicated structure, e.g., golf club heads with an inner barbed section, inner stop, or weight member that will hinder removal of the cores.

### OBJECTS OF THE INVENTION

An object of the present invention is to provide a method for manufacturing a wax pattern of a golf club head. The method includes a step of preparing an inner mold, wherein at least a portion of the inner mold is made of a liquid-soluble material such that the liquid-soluble portion of the inner mold can be dissolved after formation of a wax pattern in an outer mold, allowing subsequent removal of the wax pattern from the outer mold.

The wax pattern can be easily manufactured and design flexibility of the club head is improved. An inner perimeter of the wax pattern thus formed has no molding marks thereon. The quality of the wax pattern is improved and the casting quality of the golf club head is also improved.

### SUMMARY OF THE INVENTION

In accordance with a first aspect of the invention, a method for manufacturing a wax pattern of a golf club head comprises preparing an inner mold, at least a portion of the inner mold being made of a liquid-soluble material, with a remaining portion of the inner mold being made of an anticorrosive material not soluble by liquid, the liquid-soluble portion of the inner mold including an outer periphery complementary to a portion of an inner perimeter of a golf club head to be manufactured, the remaining portion of the inner mold including an outer periphery complementary to a remaining portion of the inner perimeter of the golf club head to be manufactured; placing the inner mold in a cavity of an outer mold, a periphery delimiting the cavity of the outer mold being complementary to an outer perimeter of the golf club head to be manufactured; filling molten wax into a space between the outer mold and the inner mold to form a heat-melting wax pattern that covers the inner mold; dissolving the liquid-soluble portion of the inner mold with a liquid; and removing the heat-melting wax pattern from the cavity of the outer mold.

In accordance with a second aspect of the invention, a method for manufacturing a wax pattern of a golf club head comprises preparing a liquid-soluble core, the liquid-soluble core including an outer periphery complementary to an inner perimeter of a golf club head to be manufactured; placing the liquid-soluble core in a cavity of an outer mold, a periphery delimiting the cavity of the outer mold being complementary to an outer perimeter of the golf club head to be manufactured; filling molten wax into a space between the outer mold and the liquid-soluble core to form a heat-melting wax pattern that covers the liquid-soluble core; dissolving the liquid-soluble core with a liquid; and removing the heat-melting wax pattern from the cavity of the outer mold.

The method may further comprise a step of immersing the heat-melting wax pattern in zirconium slurry and stucco to form a ceramic shell wax mold for producing a golf club head casting.

The liquid-soluble core is made of a material selected from a group including water-soluble wax, water-soluble resins, and water-soluble polymers. The liquid-soluble core is dissolvable in a solution selected from a group including water, alkali water solution, acidic water solution, and neutral water solution.

In accordance with a third aspect of the invention, a method for manufacturing a wax pattern of a golf club head comprises preparing an inner mold, the inner mold including at least one liquid-soluble core and a plurality of assembling cores, said at least one liquid-soluble core including an outer periphery complementary to a portion of an inner perimeter of a golf club head to be manufactured, the assembling cores being made of an anticorrosive material not soluble by liquid and including an outer periphery complementary to a remaining portion of the inner perimeter of the golf club head to be manufactured; placing the inner mold in a cavity of an outer mold, a periphery delimiting the cavity of the outer mold being complementary to an outer perimeter of the golf club head to be manufactured; filling molten wax into a space between the outer mold and the inner mold to form a heat-melting wax pattern that covers the inner mold; dissolving said at least one liquid-soluble core with a liquid; and removing the heat-melting wax pattern from the cavity of the outer mold.

The method may further comprise a step of immersing the heat-melting wax pattern in zirconium slurry and stucco to form a ceramic shell wax mold for producing a golf club head casting.

The liquid-soluble core is made of a material selected from a group including water-soluble wax, water-soluble resins, and water-soluble polymers. The liquid-soluble core is dissolvable in a solution selected from a group including water, alkali water solution, acidic water solution, and neutral water solution.

In an embodiment of the invention, the wax pattern includes a barbed section on an inner perimeter thereof. The liquid-soluble core has a shape complementary to that of the barbed section of the wax pattern.

In another embodiment of the invention, the wax pattern includes an inner stop on an inner perimeter thereof. The liquid-soluble core has a shape complementary to a portion of a shape of the inner stop. The assembling cores delimit a remaining portion of the shape of the inner stop.

In a further embodiment of the invention, the wax pattern includes a weight member on an inner perimeter thereof. The liquid-soluble core has a shape complementary to a portion of a shape of the weight member. The assembling cores delimit a remaining portion of the shape of the weight member.

In still another embodiment of the invention, the wax pattern includes a recessed portion. The liquid-soluble core has a shape complementary to a portion of a shape of the recessed portion. The assembling cores delimit a remaining portion of the shape of the recessed portion.

Other objects, advantages and novel features of this invention will become more apparent from the following detailed description when taken in conjunction with the accompanying drawings.

### BRIEF DESCRIPTION OF THE DRAWINGS

FIG. 1 is a flowchart showing a method for manufacturing a wax pattern of a golf club head in accordance with the present invention;

FIG. 2 is a sectional view illustrating formation of a liquid-soluble core in accordance with a first embodiment of the present invention;

FIG. 3 is a sectional view of the liquid-soluble core and an outer mold in accordance with the first embodiment of the present invention;

FIG. 4 is a sectional view illustrating formation of a heat-melting wax pattern in accordance with the first embodiment of the present invention;

FIG. 5 is a sectional view illustrating removal of the heat-melting pattern in accordance with the first embodiment of the present invention;

FIG. 6 is a sectional view illustrating formation of a ceramic shell wax mold after immersing the heat-melting wax pattern in zirconium slurry and stucco;

FIG. 7 is a sectional view of the ceramic shell wax mold after the heat-melting pattern is removed;

FIG. 8 is a schematic view of a golf club head casting made by the ceramic shell wax mold;

FIG. 9 is a sectional view illustrating formation of a liquid-soluble core in accordance with a second embodiment of the present invention;

FIG. 10 is an exploded sectional view of a liquid-soluble core, a plurality of assembling cores, and an outer mold in accordance with the second embodiment of the present invention;

FIG. 11 is a sectional view of the liquid-soluble core, the assembling cores, and the outer mold in FIG. 10 after assembly;

FIG. 12 is a sectional view illustrating formation of a heat-melting wax pattern in accordance with the second embodiment of the present invention;

FIG. 13 is a sectional view illustrating removal of the heat-melting pattern in accordance with the second embodiment of the present invention;

FIG. 14 is an exploded sectional view of a liquid-soluble core, a plurality of assembling cores, and an outer mold in accordance with a third embodiment of the present invention;

FIG. 15 is a sectional view of the liquid-soluble core, the assembling cores, and the outer mold in FIG. 14 after assembly;

FIG. 16 is a sectional view illustrating the heat-melting pattern in accordance with the third embodiment of the present invention;

FIG. 17 is an exploded sectional view of a liquid-soluble core, a lurality of assembling cores, and an outer mold in accordance with a fourth embodiment of the present invention;

FIG. 18 is a sectional view of the liquid-soluble core, the assembling cores, and the outer mold in FIG. 17 after assembly;

FIG. 19 is a sectional view illustrating the heat-melting pattern in accordance with the fourth embodiment of the present invention;

FIG. 20 is an exploded sectional view of two liquid-soluble cores, a plurality of assembling cores, and an outer mold in accordance with a fifth embodiment of the present invention;

FIG. 21 is a sectional view of the liquid-soluble core, the assembling cores, and the outer mold in FIG. 20 after assembly; and

FIG. 22 is a sectional view illustrating the heat-melting pattern in accordance with the fifth embodiment of the present invention.

### DETAILED DESCRIPTION OF THE PREFERRED EMBODIMENTS

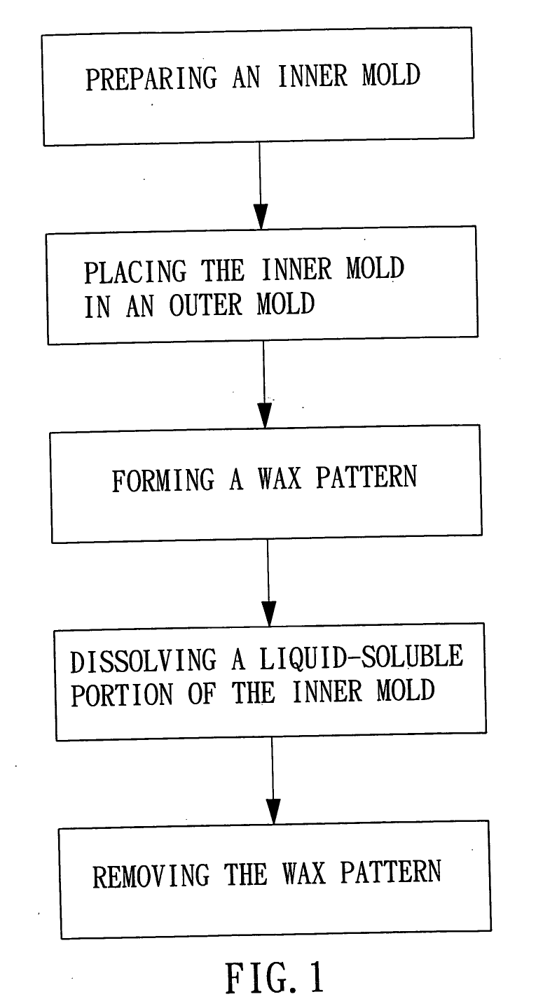

FIG. 1 is a flowchart showing a method for manufacturing a wax pattern of a golf club head in accordance with the present invention. In general, the method for manufacturing a wax pattern of a golf club head comprises preparing an inner mold, at least a portion of the inner mold being made of a liquid-soluble material, with a remaining portion of the inner mold being made of an anti-corrosion material not soluble by liquid, the liquid-soluble portion of the inner mold including an outer periphery complementary to a portion of an inner perimeter of a golf club head to be manufactured, the remaining portion of the inner mold including an outer periphery complementary to a remaining portion of the inner perimeter of the golf club head to be manufactured; placing the inner mold in a cavity of an outer mold, a periphery delimiting the cavity of the outer mold being complementary to an outer perimeter of the golf club head to be manufactured; filling molten wax into a space between the outer mold and the inner mold to form a heat-melting wax pattern that covers the inner mold; dissolving the liquid-soluble portion of the inner mold with a liquid; and removing the heat-melting wax pattern from the cavity of the outer mold.

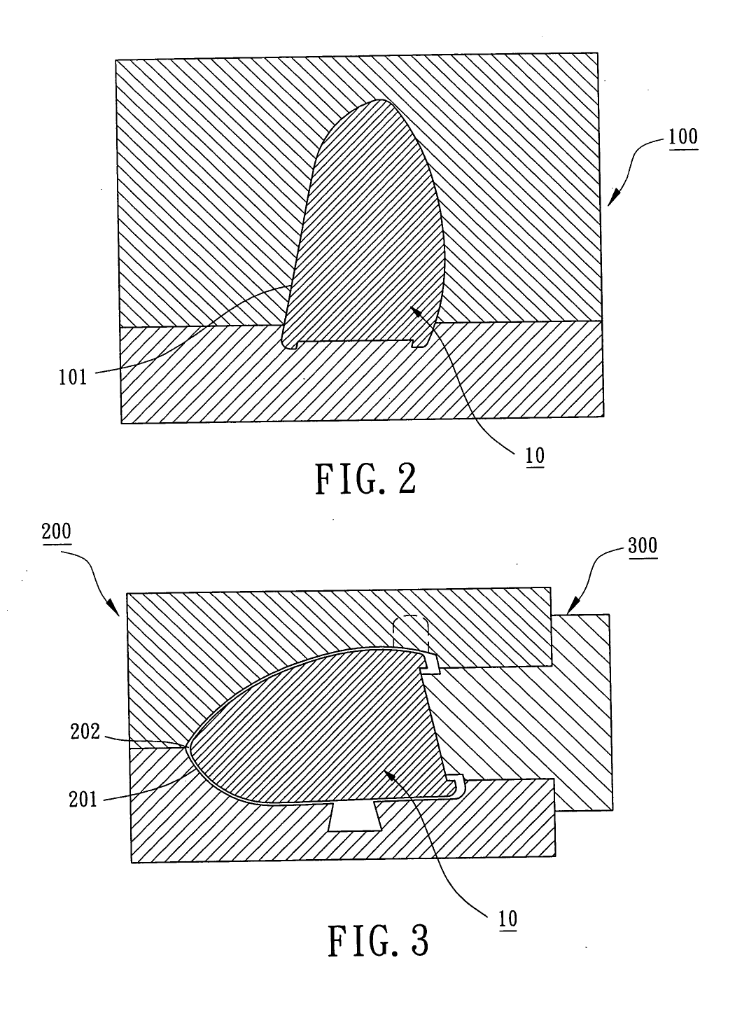

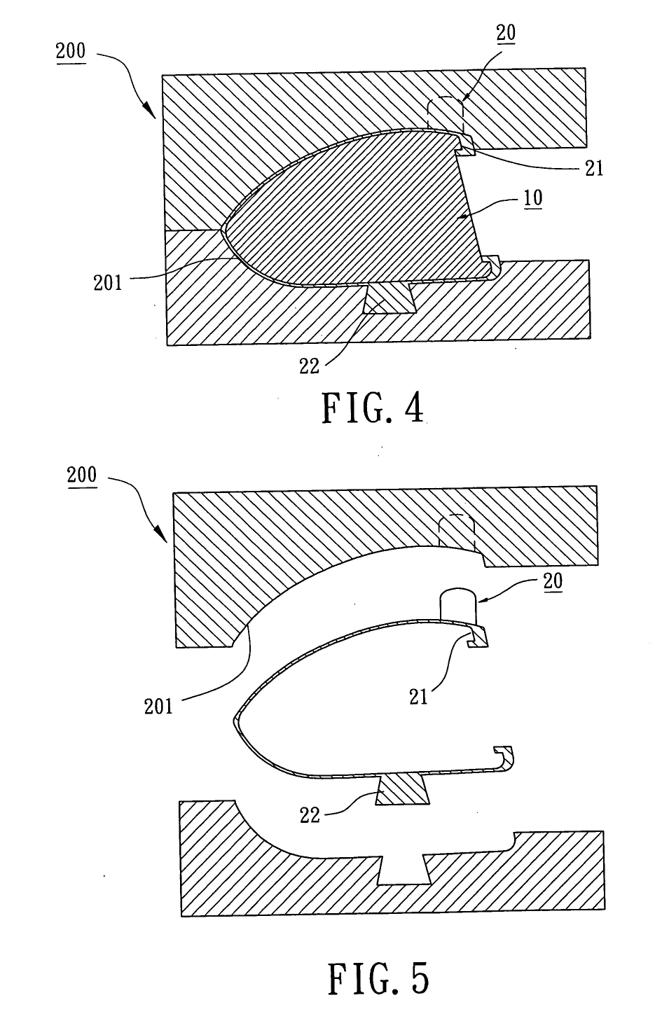

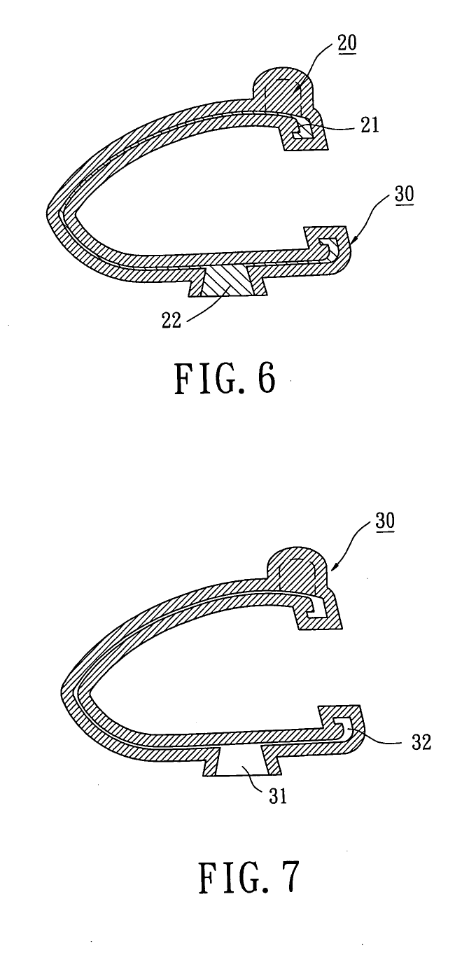

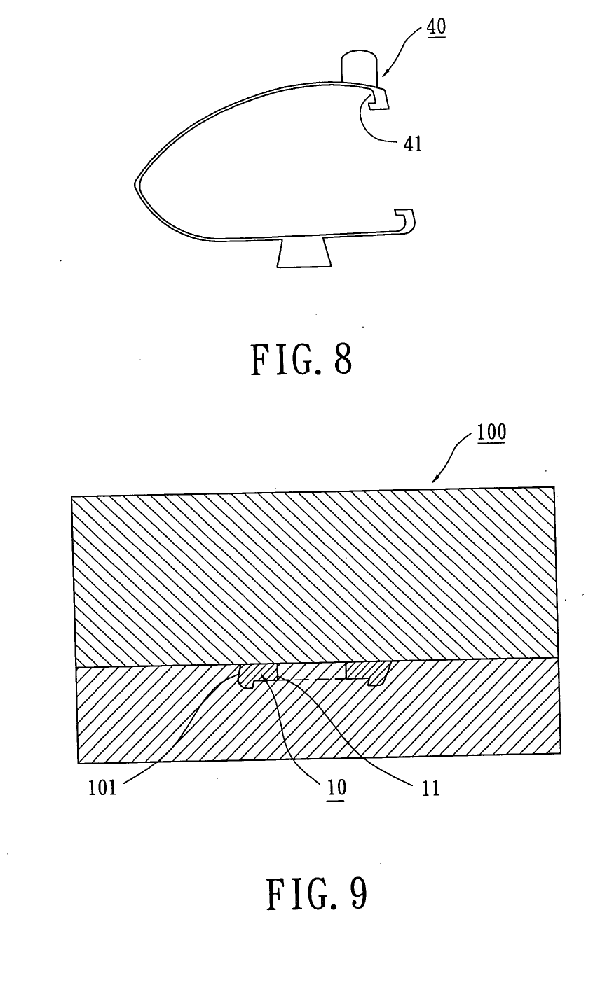

FIG. 2 is a sectional view illustrating formation of a liquid-soluble core in accordance with a first embodiment of the present invention. FIG. 3 is a sectional view of the liquid-soluble core and an outer mold in accordance with the first embodiment of the present invention. FIG. 4 is a sectional view illustrating formation of a heat-melting wax pattern in accordance with the first embodiment of the present invention. FIG. 5 is a sectional view illustrating removal of the heat-melting pattern in accordance with the first embodiment of the present invention. FIG. 6 is a sectional view illustrating formation of a ceramic shell wax mold after immersing the heat-melting wax pattern in zirconium slurry and stucco. FIG. 7 is a sectional view of the ceramic shell wax mold after the heat-melting pattern is removed. FIG. 8 is a schematic view of a golf club head casting made by the ceramic shell wax mold.

In this embodiment, the inner mold is completely made of a liquid-soluble material. In particular, a first step of the method for manufacturing a wax pattern of a golf club head of the first embodiment comprises preparing a liquid-soluble core 10. The liquid-soluble core 10 is made of a liquid-soluble material and includes an outer periphery complementary to an inner perimeter of a golf club head to be manufactured. Referring to FIG. 2, the liquid-soluble material is poured into a cavity 101 of a mold 100, wherein a periphery delimiting the cavity 101 of the mold 100 corresponds to an inner perimeter of a golf club head to be manufactured. Preferably, the liquid-soluble core 10 is made of a material selected from a group including water-soluble wax, water-soluble resins, and water-soluble polymers. The liquid-soluble material is solid at room temperature and melts at a specific high temperature. Further, the liquid-soluble material can be dissolved in water, alkali water solution, acidic water solution, or neutral water solution.

Referring to FIG. 3, the liquid-soluble core 10 is then placed in a cavity 201 of an outer mold 200. A periphery delimiting the cavity 201 of the outer mold 200 is complementary to an outer perimeter of the golf club head to be manufactured. The outer mold 200 includes a plurality of mold parts that are assembled to define the cavity 201. The liquid-soluble core 10 is supported by a supporting member 300 in the cavity 201 of the outer mold 200, with a wax-receiving space 202 being defined between the outer mold 200 and the liquid-soluble core 10. The wax-receiving space 202 is identical in shape and thickness to the golf club head to be manufactured.

Referring to FIG. 4, molten wax is filled into the wax-receiving space 202. A heat-melting wax pattern 20 covering the liquid-soluble core 10 is thus formed by injection molding. The wax melts at a specific high temperature and cannot be dissolved in water solution. Further, the melting point of the wax is lower than that of the liquid-soluble material, avoiding adverse affect to the shape of the liquid-soluble core 10 by the heat from the heat-melting wax. Thus, after cooling of the heat-melting wax, a heat-melting wax pattern 20 with the desired shape and desired thickness of a golf club head to be manufactured is obtained and covers the liquid-soluble core 10. It is noted that the heat-melting wax pattern 20 has a protrusion 22 on an outer periphery thereof.

Referring to FIG. 5, the liquid-soluble core 10 is dissolved by a liquid to allow subsequent removal of the heat-melting wax pattern 20. The liquid may be water, alkali water solution, acidic water solution, or neutral water solution, depending on the liquid-soluble material. The heat-melting wax pattern 20 is not dissolvable by the liquid and thus remains intact in its inner perimeter. The heat-melting wax pattern 20 may include a barbed section 21 on an inner perimeter thereof. Thus, the method in accordance with the present invention may be used to easily manufacture a heat-melting wax pattern 20 with a complicated inner perimeter. The design flexibility of the golf club head is increased, and the golf club head can be manufactured by a suitable process. Further, the inner perimeter of the heat-melting wax pattern 20 is smooth without any molding marks.

The heat-melting wax pattern 20 can be immersed in zirconium slurry and stucco to form a ceramic shell wax mold 30, as shown in FIG. 6. After formation of the ceramic shell wax mold 30, the heat-melting wax pattern 20 is melted and thus removed by heating, leaving the ceramic shell wax mold 30 with a cavity 32 and a sprue 31, as shown in FIG. 7. Molten metal is filled into the cavity 32 via the sprue 31 to proceed with a casting procedure. After cooling, the ceramic shell wax mold 30 is broken to obtain a golf club head casting 40 with the desired barbed section 41, as shown in FIG. 8. No molding marks can be found on an inner perimeter of the golf club head casting 40. The quality of the golf club head casting 40 is thus improved. The method in accordance with the present invention can be used to manufacture the wax pattern for all kinds of golf club heads, including wooden club heads, iron club heads, putters, and wedges.

In a case that the inner mold is not completely made of liquid-soluble material, the method for manufacturing a wax pattern of a golf club head comprises preparing an inner mold, the inner mold including at least one liquid-soluble core and a plurality of assembling cores, said at least one liquid-soluble core including an outer periphery complementary to a portion of an inner perimeter of a golf club head to be manufactured, the assembling cores including an outer periphery complementary to a remaining portion of the inner perimeter of the golf club head to be manufactured; placing the inner mold in a cavity of an outer mold, a periphery delimiting the cavity of the outer mold being complementary to an outer perimeter of the golf club head to be manufactured; filling molten wax into a space between the outer mold and the inner mold to form a heat-melting wax pattern that covers the inner mold; dissolving said at least one liquid-soluble core with a liquid; and removing the heat-melting wax pattern from the cavity of the outer mold.

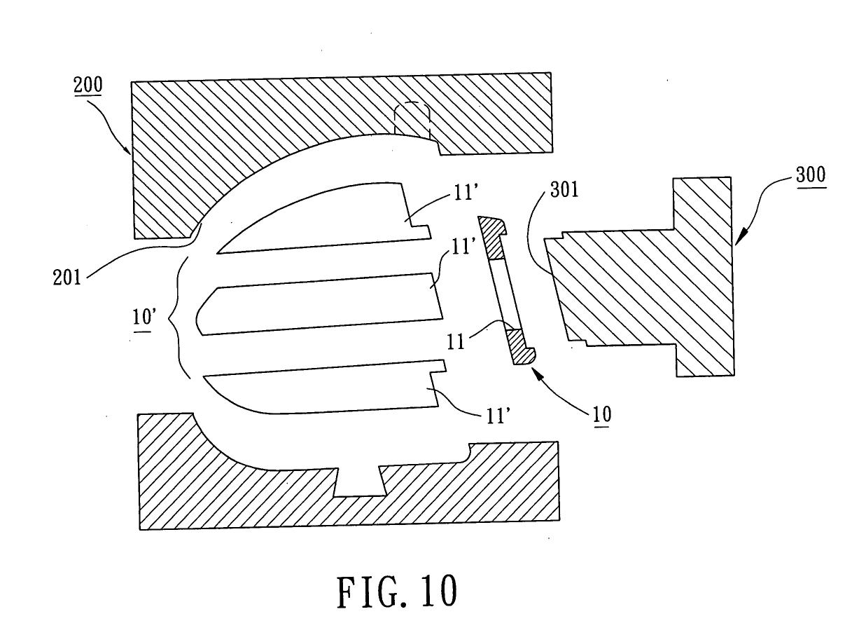

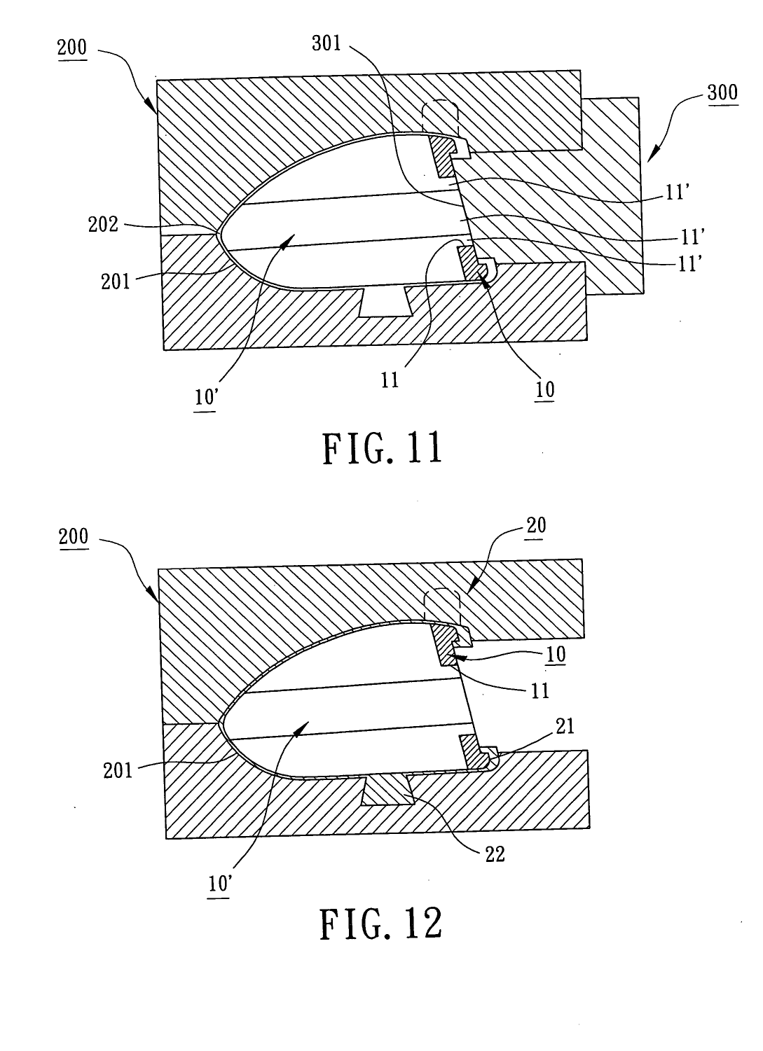

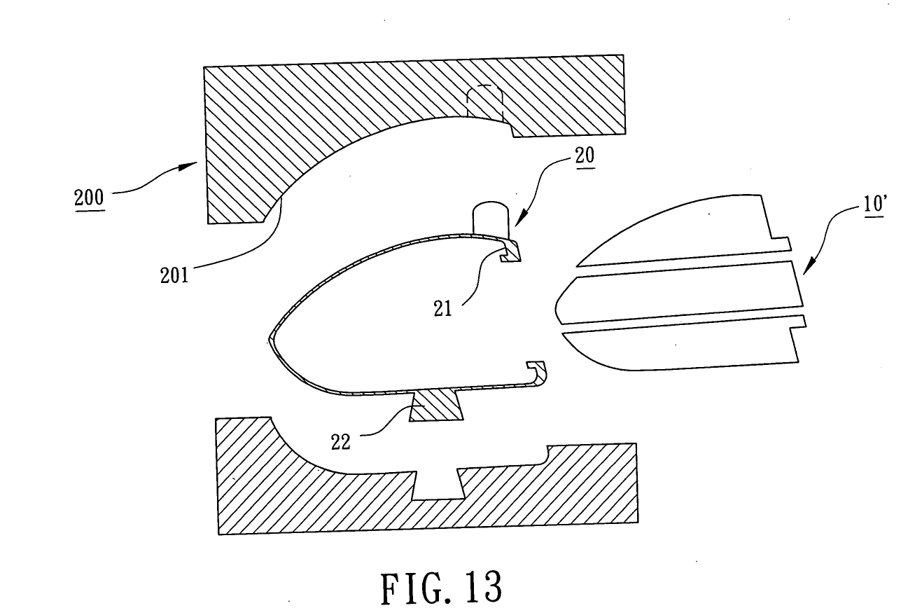

FIG. 9 is a sectional view illustrating formation of a liquid-soluble core in accordance with a second embodiment of the present invention. FIG. 10 is an exploded sectional view of a liquid-soluble core, a plurality of assembling cores, and an outer mold in accordance with the second embodiment of the present invention. FIG. 11 is a sectional view of the liquid-soluble core, the assembling cores, and the outer mold in FIG. 10 after assembly. FIG. 12 is a sectional view illustrating formation of a heat-melting wax pattern in accordance with the second embodiment of the present invention. FIG. 13 is a sectional view illustrating removal of the heat-melting pattern in accordance with the second embodiment of the present invention.

In this embodiment, a first step of the method for manufacturing a wax pattern of a golf club head comprises preparing an inner mold. The inner mold includes a liquid-soluble core 10 and a plurality of assembling cores 10′. Liquid-soluble material is poured into a cavity 101 of a mold 100, as shown in FIG. 9. The liquid-soluble material is the same as those mentioned in the first embodiment. The liquid-soluble core 10 includes an outer periphery complementary to a portion of an inner perimeter of a golf club head to be manufactured. For example, the outer periphery of the liquid-soluble core 10 is complementary to a barbed section of the inner perimeter of the golf club head to be manufactured. The assembling cores 10′ after assembly include an outer periphery complementary to the remaining portion of the inner perimeter of the golf club head to be manufactured. Thus, the liquid-soluble core 10 and the assembling cores 10′ together form an inner mold having an outer perimeter complementary to the whole inner perimeter of the golf club head to be manufactured. The assembling cores 10′ are made of metals, alloys, plastics, or plastic steels that are anticorrosive material not soluble by liquid.

The liquid-soluble core 10 and the assembling cores 10′ are assembled together to form the inner mold that is then placed into a cavity 201 of an outer mold 200, as shown in FIGS. 10 and 11. The liquid-soluble core 10 has a through-hole 11 for receiving an end section 11′ of each assembling core 10′. A section 301 of a supporting member 300 presses against the end sections 11′ of the assembling cores 10′ and the liquid-soluble core 10 to thereby position the whole inner mold in the outer mold 200, as shown in FIG. 11. A periphery delimiting the cavity 201 of the outer mold 200 is complementary to an outer perimeter of the golf club head to be manufactured. A wax-receiving space 202 is defined between the outer mold 200 and the inner mold. The wax-receiving space 202 is identical in shape and thickness to the golf club head to be manufactured.

Next, molten wax is filled into the wax-receiving space 202 to form a heat-melting wax pattern 20 that covers the inner mold. A heat-melting wax pattern 20 covering the liquid-soluble core 10 is thus formed by injection molding, as shown in FIG. 12. The wax melts at a specific high temperature and cannot be dissolved in water solution. Further, the melting point of the wax is lower than that of the liquid-soluble material, avoiding adverse affect to the shape of the liquid-soluble core 10 by the heat from the heat-melting wax. Thus, after cooling of the heat-melting wax, a heat-melting wax pattern 20 with the desired shape and desired thickness of a golf club head to be manufactured is obtained and covers the liquid-soluble core 10. It is noted that the heat-melting wax pattern 20 has a protrusion 22 on an outer periphery thereof and a barbed section 21 on an inner perimeter thereof.

The liquid-soluble core 10 is dissolved by a liquid to allow subsequent removal of the heat-melting wax pattern 20. The liquid may be water, alkali water solution, acidic water solution, or neutral water solution, depending on the liquid-soluble material. The heat-melting wax pattern 20 is not dissolvable by the liquid and thus remains intact in its inner perimeter. After the liquid-soluble core 10 is dissolved, the assembling cores 10′ can be removed from the cavity 201 of the outer mold 200, allowing subsequent removal of the heat-melting wax pattern 20. The heat-melting wax pattern 20 can be used to manufacture a golf club head by investment casting, as mentioned above with reference to FIGS. 6 through 8.

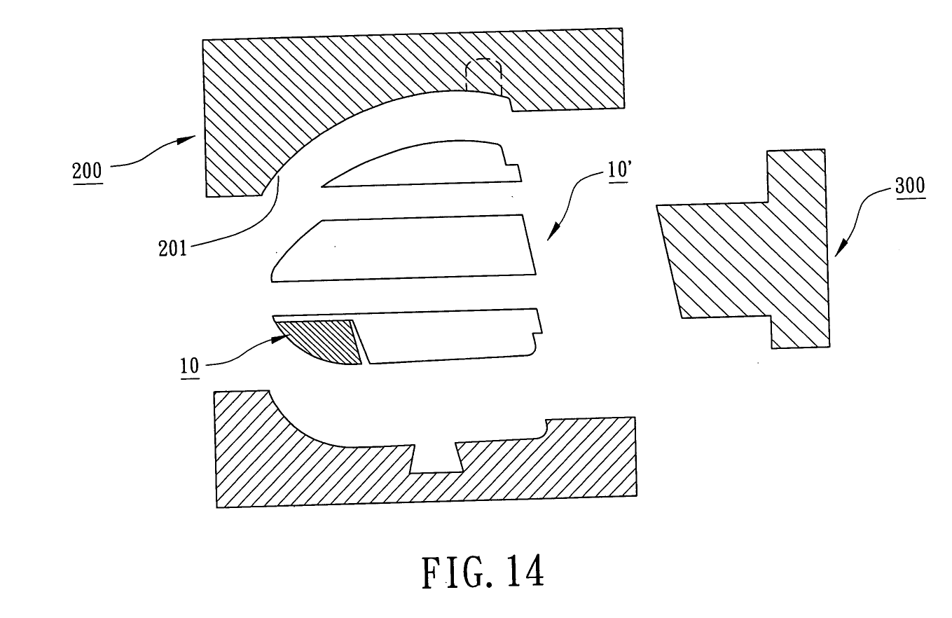

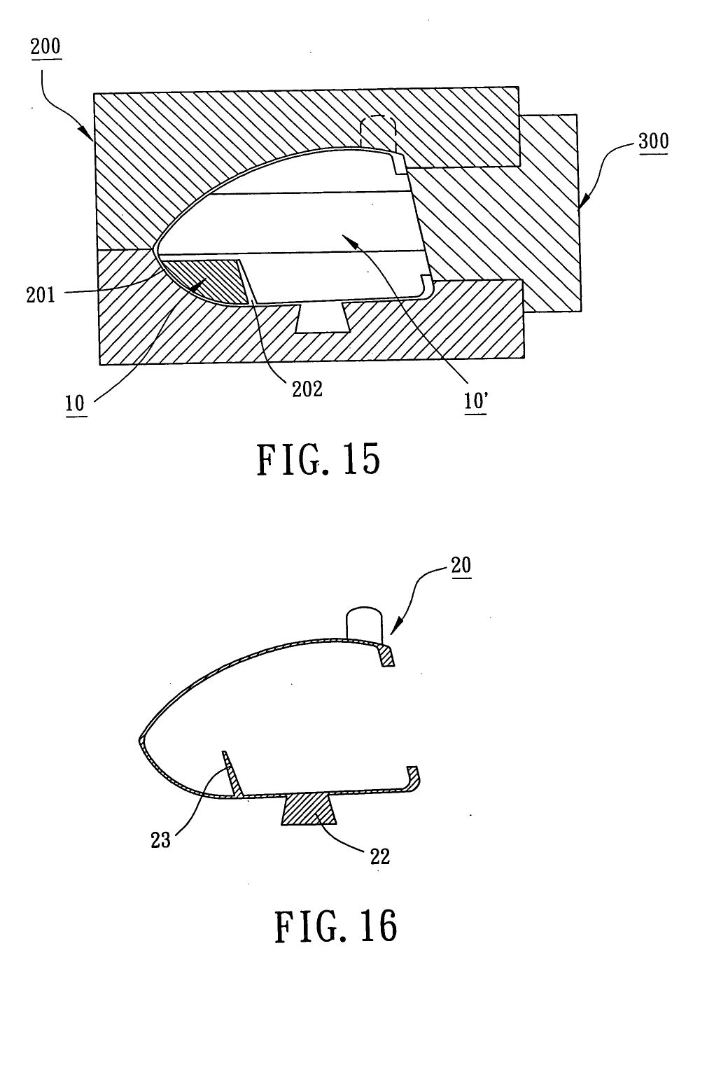

FIG. 14 is an exploded sectional view of a liquid-soluble core, a plurality of assembling cores, and an outer mold in accordance with a third embodiment of the present invention. FIG. 15 is a sectional view of the liquid-soluble core, the assembling cores, and the outer mold in FIG. 14 after assembly. FIG. 16 is a sectional view illustrating the heat-melting pattern in accordance with the third embodiment of the present invention.

The difference between the third embodiment and the second embodiment is that the liquid-soluble core 10 of the third embodiment corresponds to a portion of an inner perimeter of the golf club head to be manufactured such that a heat-melting wax pattern 20 with an inner stop 23 is formed after the step of formation of the wax pattern 20. Namely, the liquid-soluble core 10 has a shape complementary to a portion of a shape of the inner stop 23. The assembling cores 10′ delimit the remaining portion of the shape of the inner stop 23. The liquid-soluble core 10 is fixed to the assembling cores 10′ by adhesive or riveting. After the liquid-soluble core 10 is dissolved, the assembling cores 10′ can be removed from the cavity 201 of the outer mold 200, allowing subsequent removal of the heat-melting wax pattern 20. The heat-melting wax pattern 20 can be used to manufacture a golf club head with an inner stop.

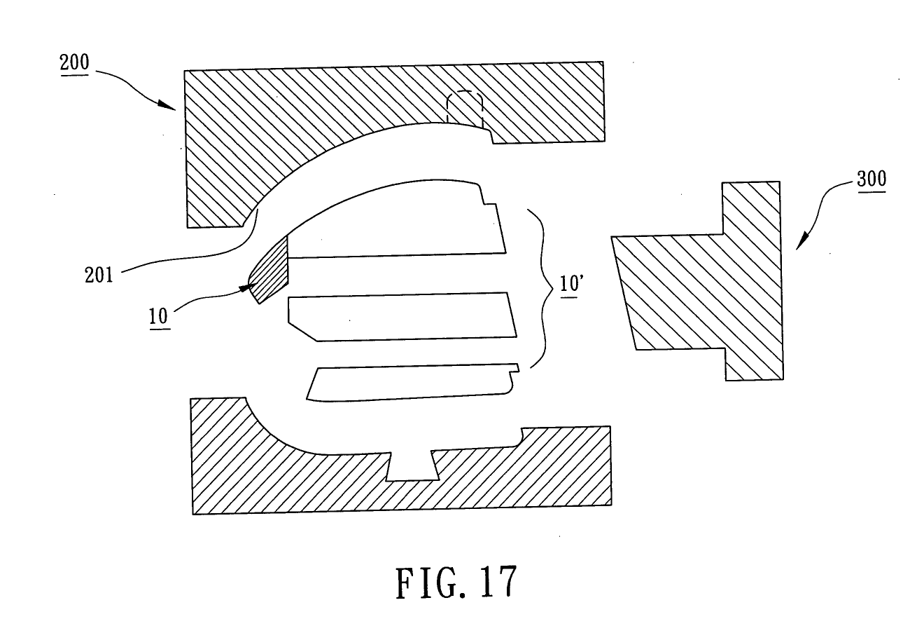

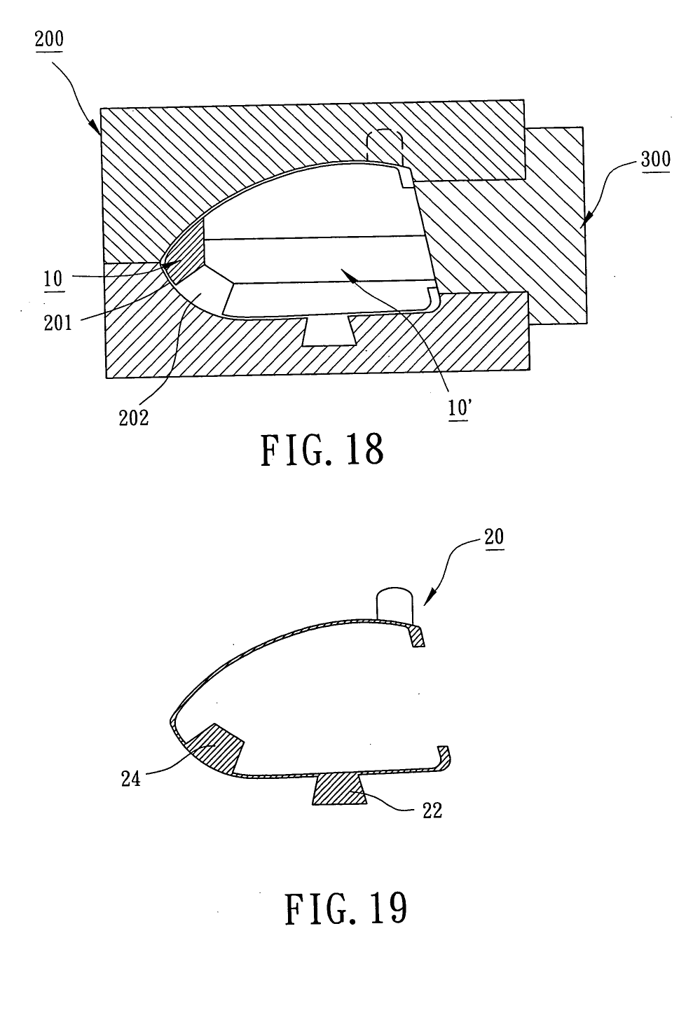

FIG. 17 is an exploded sectional view of a liquid-soluble core, a plurality of assembling cores, and an outer mold in accordance with a fourth embodiment of the present invention. FIG. 18 is a sectional view of the liquid-soluble core, the assembling cores, and the outer mold in FIG. 17 after assembly. FIG. 19 is a sectional view illustrating the heat-melting pattern in accordance with the fourth embodiment of the present invention.

The difference between the fourth embodiment and the second embodiment is that the liquid-soluble core 10 of the fourth embodiment corresponds to a portion of an inner perimeter of the golf club head to be manufactured such that a heat-melting wax pattern 20 with an integral weight member 24 is formed after the step of formation of the wax pattern 20. Namely, the liquid-soluble core 10 has a shape complementary to a portion of a shape of the weight member 24. The assembling cores 10′ delimit a remaining portion of the shape of the weight member 24. The liquid-soluble core 10 is fixed to the assembling cores 10′ by adhesive or riveting. After the liquid-soluble core 10 is dissolved, the assembling cores 10′ can be removed from the cavity 201 of the outer mold 200, allowing subsequent removal of the heat-melting wax pattern 20. The heat-melting wax pattern 20 can be used to manufacture a golf club head with an inner integral weight member.

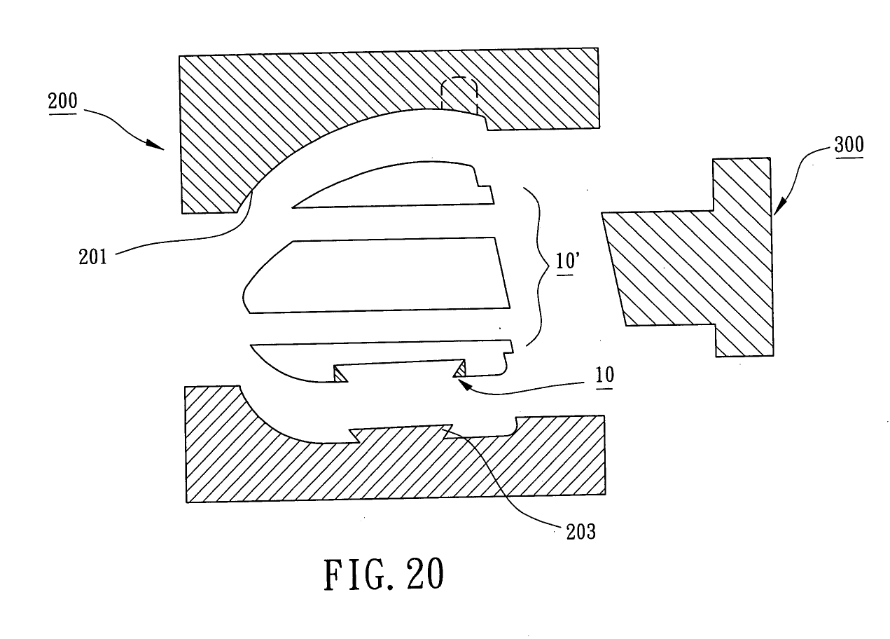

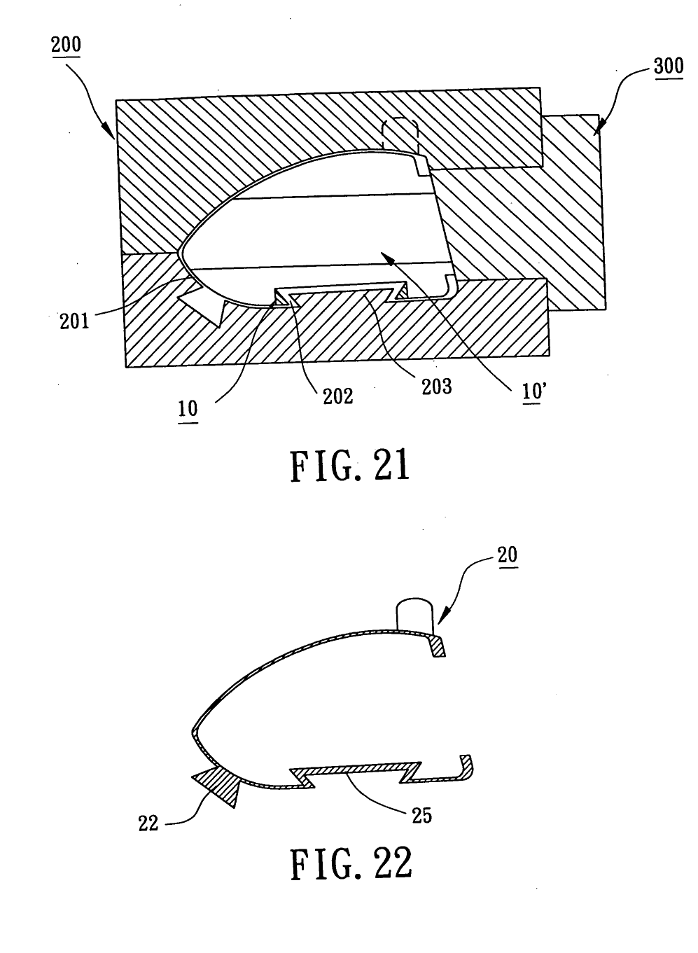

FIG. 20 is an exploded sectional view of two liquid-soluble cores, a plurality of assembling cores, and an outer mold in accordance with a fifth embodiment of the present invention. FIG. 21 is a sectional view of the liquid-soluble core, the assembling cores, and the outer mold in FIG. 20 after assembly. FIG. 22 is a sectional view illustrating the heat-melting pattern in accordance with the fifth embodiment of the present invention.

The difference between the fifth embodiment and the second embodiment is that there are two liquid-soluble cores 10 in the fifth embodiment that correspond to two portions of an inner perimeter of the golf club head to be manufactured such that a heat-melting wax pattern 20 with a trapezoid recessed portion 25 is formed after the step of formation of the wax pattern 20. Namely, the liquid-soluble cores 10 have a shape complementary to a portion of a shape of the recessed portion 25. The assembling cores 10′ delimit the remaining portion of the shape of the recessed portion 25. The liquid-soluble cores 10 are fixed to the assembling cores 10′ by adhesive or riveting. After the liquid-soluble core 10 is dissolved, the assembling cores 10′ can be removed from the cavity 201 of the outer mold 200, allowing subsequent removal of the heat-melting wax pattern 20. The heat-melting wax pattern 20 can be used to manufacture a golf club head with a recessed portion.

The methods in accordance with the present invention may be used to easily manufacture a heat-melting wax pattern 20 with a complicated inner perimeter. The design flexibility of the golf club head is increased, and the golf club head can be manufactured by a suitable process. Further, the inner perimeter of the heat-melting wax pattern is smooth without any molding marks.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A method for manufacturing a wax pattern of a golf club head, the method comprising:
preparing an inner mold, at least a portion of the inner mold being made of a liquid-soluble material, with a remaining portion of the inner mold being made of an anticorrosive material not soluble by liquid, the liquid-soluble portion of the inner mold including an outer periphery complementary to a portion of an inner perimeter of a golf club head to be manufactured, the remaining portion of the inner mold including an outer periphery complementary to a remaining portion of the inner perimeter of the golf club head to be manufactured;
placing the inner mold in a cavity of an outer mold, a periphery delimiting the cavity of the outer mold being complementary to an outer perimeter of the golf club head to be manufactured;
filling molten wax into a space between the outer mold and the inner mold to form a heat-melting wax pattern that covers the inner mold;
dissolving the liquid-soluble portion of the inner mold with a liquid; and
removing the heat-melting wax pattern from the cavity of the outer mold.

2. The method as claimed in claim 1, further comprising a step of immersing the heat-melting wax pattern in zirconium slurry and stucco to form a ceramic shell wax mold for producing a golf club head casting.

3. The method as claimed in claim 1, wherein the liquid-soluble core is made of a material selected from a group including water-soluble wax, water-soluble resins, and water-soluble polymers.

4. The method as claimed in claim 3, wherein the liquid-soluble core is dissolvable in a solution selected from a group including water, alkali water solution, acidic water solution, and neutral water solution.

5. The method as claimed in claim 1, wherein the wax pattern includes a barbed section on an inner perimeter thereof, the liquid-soluble core having a shape complementary to that of the barbed section of the wax pattern.

6. The method as claimed in claim 1, wherein the wax pattern includes an inner stop on an inner perimeter thereof, the liquid-soluble core having a shape complementary to a portion of a shape of the inner stop, the assembling cores delimiting a remaining portion of the shape of the inner stop.

7. The method as claimed in claim 1, wherein the wax pattern includes a weight member on an inner perimeter thereof, the liquid-soluble core having a shape complementary to a portion of a shape of the weight member, the assembling cores delimiting a remaining portion of the shape of the weight member.

8. The method as claimed in claim 1, wherein the wax pattern includes a recessed portion, the liquid-soluble core having a shape complementary to a portion of a shape of the recessed portion, the assembling cores delimiting a remaining portion of the shape of the recessed portion.

9. A method for manufacturing a wax pattern of a golf club head, the method comprising:
preparing a liquid-soluble core, the liquid-soluble core including an outer periphery complementary to an inner perimeter of a golf club head to be manufactured;
placing the liquid-soluble core in a cavity of an outer mold, a periphery delimiting the cavity of the outer mold being complementary to an outer perimeter of the golf club head to be manufactured;
filling molten wax into a space between the outer mold and the liquid-soluble core to form a heat-melting wax pattern that covers the liquid-soluble core;
dissolving the liquid-soluble core with a liquid; and
removing the heat-melting wax pattern from the cavity of the outer mold.

10. The method as claimed in claim 9, further comprising a step of immersing the heat-melting wax pattern in zirconium slurry and stucco to form a ceramic shell wax mold for producing a golf club head casting.

11. The method as claimed in claim 9, wherein the liquid-soluble core is made of a material selected from a group including water-soluble wax, water-soluble resins, and water-soluble polymers.

12. The method as claimed in claim 9, wherein the liquid-soluble core is dissolvable in a solution selected from a group including water, alkali water solution, acidic water solution, and neutral water solution.

13. A method for manufacturing a wax pattern of a golf club head, the method comprising:
preparing an inner mold, the inner mold including at least one liquid-soluble core and a plurality of assembling cores, said at least one liquid-soluble core including an outer periphery complementary to a portion of an inner perimeter of a golf club head to be manufactured, the assembling cores being made of an anticorrosive material not soluble by liquid and including an outer periphery complementary to a remaining portion of the inner perimeter of the golf club head to be manufactured;
placing the inner mold in a cavity of an outer mold, a periphery delimiting the cavity of the outer mold being complementary to an outer perimeter of the golf club head to be manufactured;
filling molten wax into a space between the outer mold and the inner mold to form a heat-melting wax pattern that covers the inner mold;
dissolving said at least one liquid-soluble core with a liquid; and
removing the heat-melting wax pattern from the cavity of the outer mold.

14. The method as claimed in claim 13, further comprising a step of immersing the heat-melting wax pattern in zirconium slurry and stucco to form a ceramic shell wax mold for producing a golf club head casting.

15. The method as claimed in claim 13, wherein said at least one liquid-soluble core is made of a material selected from a group including water-soluble wax, water-soluble resins, and water-soluble polymers.

16. The method as claimed in claim 13, wherein said at least one liquid-soluble core is dissolvable in a solution selected from a group including water, alkali water solution, acidic water solution, and neutral water solution.

17. The method as claimed in claim 13, wherein the wax pattern includes a barbed section on an inner perimeter thereof, said at least one liquid-soluble core having a shape complementary to that of the barbed section of the wax pattern.

18. The method as claimed in claim 13, wherein the wax pattern includes an inner stop on an inner perimeter thereof, said at least one liquid-soluble core having a shape complementary to a portion of a shape of the inner stop, the assembling cores delimiting a remaining portion of the shape of the inner stop.

19. The method as claimed in claim 13, wherein the wax pattern includes a weight member on an inner perimeter thereof, said at least one liquid-soluble core having a shape complementary to a portion of a shape of the weight member, the assembling cores delimiting a remaining portion of the shape of the weight member.

20. The method as claimed in claim 13, wherein the wax pattern includes a recessed portion, said at least one liquid-soluble core having a shape complementary to a portion of a shape of the recessed portion, the assembling cores delimiting a remaining portion of the shape of the recessed portion.
